(19) United States
(12) Patent Application Publication
(10) Pub. No.: US 2024/0411453 A1
(43) Pub. Date: Dec. 12, 2024

(54) Live Migration Method and System Thereof

(71) Applicant: Wistron Corporation, New Taipei City (TW)

(72) Inventor: Chih-Ming Chen, New Taipei City (TW)

(73) Assignee: Wistron Corporation, New Taipei City (TW)

(21) Appl. No.: 18/229,649

(22) Filed: Aug. 2, 2023

(30) Foreign Application Priority Data
Jun. 6, 2023 (TW) 112120998

(51) Int. Cl. G06F 3/06

(52) U.S. Cl. CPC G06F 3/0611; G06F 3/0647; G06F 3/067

(57) ABSTRACT

A live migration method for a shared memory of a system includes receiving a state of a first system-on-chip, and storing the state for reading. The first system-on-chip is configured to write the state of the first system-on-chip into the shared memory; a second system-on-chip is configured to read the state from the shared memory. The shared memory is constructed at least from at least part of a first memory of the first system-on-chip, at least part of a second memory of the second system-on-chip, or at least part of a third memory of the system.

### BACKGROUND OF THE INVENTION

### 1. Field of the Invention

The present invention relates to a live migration method and a system thereof, and more particularly, to a live migration method and a system capable of improving user experience.

### 2. Description of the Prior Art

Traditionally edge computing platforms (e.g., VMWare) use virtual machine (VM) hypervisors to facilitate edge clouds. When performing VM live migration from a source to a destination on a network, a VM hypervisor first freezes/suspends the VM and save the VM state on the source. Subsequently, the VM hypervisor copies the VM state from the source to the destination via the network, and the VM hypervisor then resumes the VM from the VM state on the destination. The whole steps conducted by the VM hypervisor take milliseconds.

In addition, for VM provisioning, the VM hypervisor first allocates VM resources like CPUs, memory, PCIe cards (e.g., GPUs, NICs), then loads the corresponding VM image from VM storage into the VM, and finally lets the VM boot from the VM image. Again, the whole steps conducted by the VM hypervisor take minutes.

However, URLLC of 5G allows only 1 millisecond of end-to-end latency. Any end-to-end latency exceeding 1 millisecond will result in service interruption of a user equipment (UE).

### SUMMARY OF THE INVENTION

It is therefore an objective of the present invention to provide a live migration method and a system thereof to improve over disadvantages of the prior art.

An embodiment of the present invention discloses a live migration method, for a shared memory of a system, comprising receiving a state of a first system-on-chip (SoC), wherein the first SoC is configured to write the state of the first SoC into the shared memory; and storing the state for reading, wherein a second SoC is configured to read the state from the shared memory, wherein the shared memory is constructed at least from at least part of a first memory of the first SoC, at least part of a second memory of the second SoC, or at least part of a third memory of the system.

An embodiment of the present invention discloses a comprising a first system-on-chip (SoC), configured to write a state of the first SoC into a shared memory; and a second SoC, coupled to the first SoC, configured to read the state from the shared memory, wherein the shared memory is constructed at least from at least part of a first memory of the first SoC, at least part of a second memory of the second SoC, or at least part of a third memory of the system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 3 are schematic diagrams of systems according to embodiments of the present invention.

FIG. 4 is a schematic diagram of a system-on-chip according to an embodiment of the present invention.

FIG. 5 to FIG. 6 are schematic diagrams of systems according to embodiments of the present invention.

FIG. 7 is a schematic diagram of a live migration method according to an embodiment of the present invention.

### DETAILED DESCRIPTION

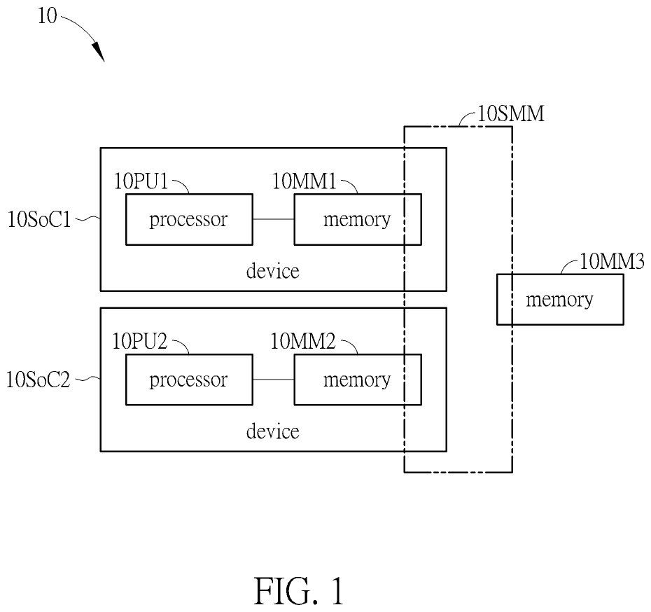

FIG. 1 is a schematic diagram of a system 10 according to an embodiment of the present invention. The system 10 may include devices 10SoC1, 10SoC2, and a memory 10MM3 coupled to each other. The devices 10SoC1 and 10SoC2 may include processors 10PU1, 10PU2, memory 10MM1, and 10MM2, respectively. In an embodiment, the devices 10SoC1, 10SoC2, and the memory 10MM3 may be disposed in different (or the same) server(s), chassis, or rack(s), but not limited thereto. In an embodiment, the device 10SoC1 and the memory 10MM3 may be disposed in the same server separately.

In an embodiment, the device 10SoC1 (or 10SoC2) may be implemented by a system-on-chip (SoC). In the present invention, live migration refers to the process of moving/transferring (the operation or state of) a running SoC between different physical devices without disconnecting/disrupting its application or client. The (content or state of) memory, storage, or/and network connectivity/connection of the SoC is/are transferred from a source (e.g., the device 10SoC1) to a destination (e.g., the device 10SoC2). The time between suspending/stopping (the operation of) a system-on-chip on the source and resuming it on the destination is called downtime. When the downtime of a system-on-chip during live migration is short enough that it is not noticeable by the user (e.g., less than or much less than 1 millisecond), it is called a seamless live migration that the present invention intends to achieve.

In an embodiment, at least one of the memory 10MM1-10MM3, certain storage unit(s) of the memory 10MM1-10MM3 (e.g., part of the memory 10MM1), or a combination thereof may constitute/create or be used as a shared memory 10SMM for the devices 10SoC1 and 10SoC2. In an embodiment, with compute express link (CXL) 3.0, the state of a system-on-chip may be saved at a CXL shared memory among all CXL nodes (e.g., CPU(s) or device(s)) across different servers or racks. In an embodiment, right after a system-on-chip (e.g., the device 10SoC1) on the source saves its state on the shared memory 10SMM (e.g., the CXL shared memory), another SoC (e.g., the device 10SoC2) on the destination may resume/restore the state immediately from the shared memory 10SMM. As a result, there is no state copy between the source and the destination anymore: As the state is stored in the shared memory 10SMM, there is no need to copy the state or copy the state via the network. The state of the device 10SoC1 may be transmitted using, for example, peripheral component interconnect express (PCIe) or CXL link(s) rather than using the network for transmission. Accordingly, seamless live migration may be realized, and the requirements of ultra-reliable and low latency communications (URLLC) of 5th generation mobile networks (5G) may be met.

In an embodiment, since the devices 10SoC1 (or 10SoC2) may be implemented by a system-on-chip, the devices 10SoC1 (or 10SoC2) itself may include the processor 10PU1, 10PU2 (e.g., a central processing unit (CPU)), the memory 10MM1, 10MM2, or storage. In other words, unlike resuming a virtual machine (VM) at the destination, which requires to allocate resources of virtual CPU(s), virtual memory, or virtual storage, the device 10SoC2 (or 10SoC1) does not need to perform VM provisioning after reading the state from the shared memory 10SMM (e.g., step S704), which saves time spent on (computing, storage, or network) resource allocation. This enables seamless live migration and meets the requirements of URLLC of 5G.

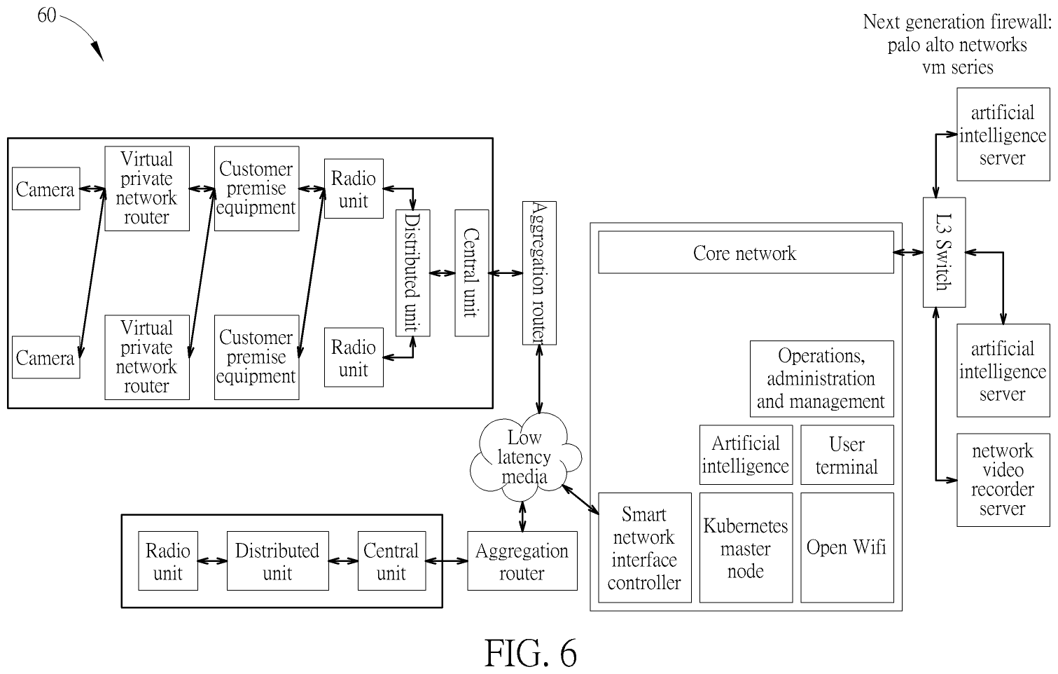

In an embodiment, live migration may involve migrating/moving a user plane function (UPF) from one (busy) server to another (idle) server. If the live migration takes too long, it can affect user experience (e.g., causing accident(s) in unmanned self-driving car(s) due to delayed reactions). The system 10 may ensure that the latency from the client (e.g., an unmanned self-driving car, a user equipment, or a camera shown in FIG. 6) to the server (e.g., an artificial intelligence (AI) server shown in FIG. 6) is less than 1 millisecond.

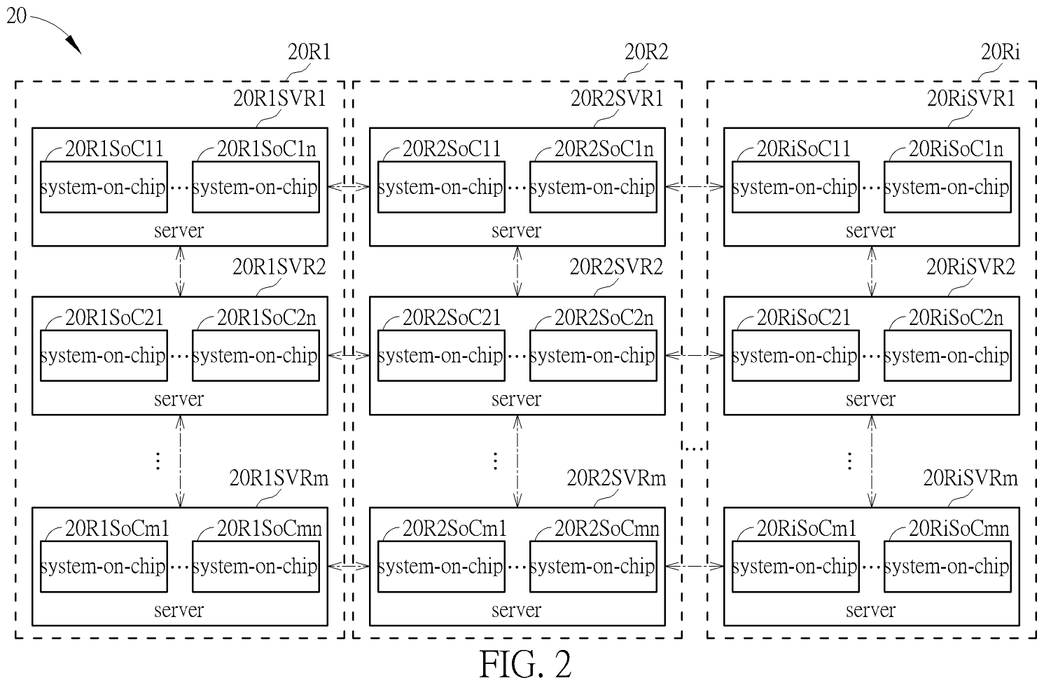

FIG. 2 is a schematic diagram of a system 20 according to an embodiment of the present invention. The system 20 may include racks 20R1 to 20Ri. The racks 20R1-20Ri may include servers 20R1SVR1 to 20RiSVRm, respectively; the servers 20R1SVR1-20RiSVRm may include system-on-chips 20R1SoC11 to 20RiSoCmn, respectively, where i, m, and n are positive integers. In an embodiment, the structure of different racks/servers (e.g., the number of its servers or SoCs) may be different.

Similar to the system 10, part or all memory of the system-on-chips 20R1SoC11-20RiSoCmn or the servers 20R1SVR1-20RiSVRm or the combination thereof may form/constitute a shared memory. The servers 20R1SVR1-20RiSVRm may be interconnected with each other by CXL links (indicated by the double arrowed dash-dotted lines shown in FIG. 2). In other words, SoCs may utilize memory channels/buses (e.g., between the processor 10PU1 and the memory 10MM1) or CXL links or PCIe buses (e.g., between the devices 10SoC1 and 10SoC2) to read/write a shared memory. For example, the system-on-chip 20R1SoC11 at the source may store its state (e.g., an user plane function) in the shared memory, and the system-on-chip 20R2SoC11 at the destination may use its CXL link to directly read the state from the shared memory to resume the state (e.g., step S704). Accordingly, the seamless live migration of a system-on-chip across servers or even across racks may be achieved.

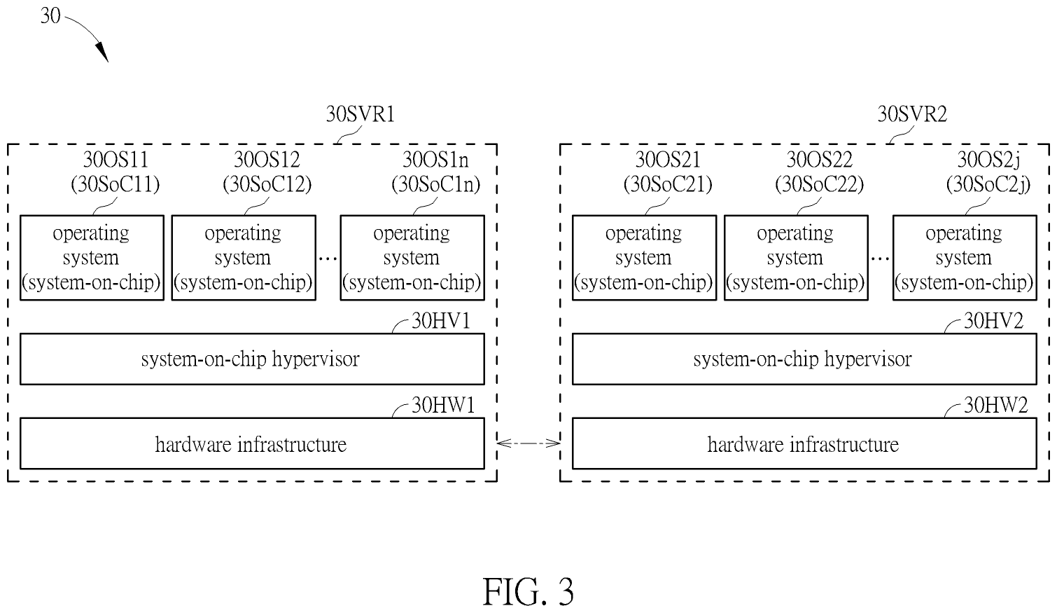

FIG. 3 is a schematic diagram of a system 30 according to an embodiment of the present invention. The system 30 may include servers 30SVR1 and 30SVR2. The servers 30SVR1 and 30SVR2 may include hardware infrastructures 30HW1, 30HW2, SoC hypervisors 30HV1, 30HV2, operating systems 300S11 to 300S1n, and 300S21 to 300S2j, respectively, where j is a positive integer. System-on-chips 30SoC11 to 30SoC1n, 30SoC21 to 30SoC2j are corresponding to the operating systems 300S11-300S1n, 300S21-30OS2j, respectively. The servers 30SVR1 and 30SVR2 may be interconnected with each other using a CXL link (represented by a double arrowed dash-dotted line shown in FIG. 3).

To ensure security, as shown in FIG. 3, the SoC hypervisor 30HV1 (or 30HV2) is a type I SoC hypervisor; that is, the SoC hypervisor 30HV1 is directly installed on the hardware infrastructure 30HW1 and may have direct access to or control over hardware resources. There is no additional operating system (OS) layer between the SoC hypervisor 30HV1 and the hardware infrastructure 30HW1, so it is difficult to attack the system 30. In other words, the server (e.g., 30HV1) does not have an operating system installed to improve security. A type I SoC hypervisor ensures better security than a type II SoC hypervisor, which has an extra OS layer vulnerable to attacks.

Please note that the operating systems 300S11-300S1n run on the system-on-chips 30SoC11-30SoC1n, respectively. The SoC hypervisor 30HV1 manages the system-on-chips 30SoC11-30SoC1n, which are hardware, rather than the operating system 300S11-30OS1n. Therefore, the hypervisor 30HV1 is different from a VM hypervisor that manages virtual machines. The SoC hypervisor 30HV1 (or 30HV2) may be implemented using a combination of software, firmware, or hardware.

In an embodiment, an operating system (e.g., 300S11) may be embedded Linux running in a system-on-chip (e.g., 30SoC11). In an embodiment, a plurality of system-on-chips (e.g., 30SoC11-30SoC14) may be disposed in an interface card (which is inserted into a server (e.g., 30SVR1)). In an embodiment, a hardware infrastructure (e.g., 30HW1) may include CPU(s) or memory (e.g., dynamic random access memory (DRAM)) of a system-on-chip (e.g., 30SoC11) or a server (e.g., 30SVR1).

In an embodiment, two techniques for transferring the memory state of a system-on-chip from a source to a destination may be pre-copy memory migration and post-copy memory migration. If a memory page becomes dirtied repeatedly at the source during migration, the post-copy memory migration reads/transfers each memory page exactly once over the CXL shared memory whereas the pre-copy memory migration reads/transfers the same memory page multiple times (in response to the occurrence of being dirtied). The pre-copy memory migration retains an up-to-date state of the SoC at the source during migration, whereas the state of the SoC under the post-copy memory migration is split across the source and the destination (i.e., the state of the system-on-chip (e.g., 20R1SoC11) at the source is different from the state of the system-on-chip (e.g., 20R2SoC11) at the destination). If the destination fails during live migration, the pre-copy memory migration may recover the SoC successfully, whereas the post-copy memory migration may not. Therefore, the present invention may adopt the pre-copy memory migration in an embodiment.

In an embodiment, the pre-copy memory migration may be divided into a pre-copy phase and a stop-and-copy phase. In the pre-copy phase, the SoC hypervisor (e.g. 30HV1) ensures that all memory pages of the system-on-chip (e.g. 30SoC11) on the source are stored in the CXL shared memory (e.g., to copy the memory pages from the source to the CXL shared memory), while the SoC is still running on the source. If some memory pages change (and thus become dirty) during the pre-copy phase, the changed memory pages will be copied again and again over several pre-copy rounds (and kept/saved in an area of the CXL shared memory). The pre-copy phase may end when the number of dirtied/changed memory pages remaining becomes small enough to yield a short stop-and-copy phase. On the other hand, if a SoC keeps dirtying/changing memory page(s) faster than than can be iteratively transmitted to the destination (e.g., the rate at which the SoC changes memory page(s) is faster than the rate at which the destination reads the memory page(s) sequentially), the pre-copy phase will end after a predetermined/preset time limit or a maximum number of pre-copy rounds to begin the next stop-and-copy phase. In the stop-and-copy phase (or after the pre-copy phase), the SoC will be paused on the source, and the remaining dirty/changed memory page(s) will be transferred/transmitted to the destination (e.g., for the destination to read the remaining dirty/changed memory page(s)), such that the system-on-chip (e.g., 30SoC2j) will be resumed at the destination. The downtime due to the stop-and-copy phase may range from a few milliseconds to seconds depending on the number of dirty/changed memory pages transferred during downtime. A system-on-chip that dirties a lot of memory pages during the pre-copy phase tends to have a larger downtime.

In FIG. 3, before live migration, an operating system (e.g., 300S11) has been already installed on the system-on-chip (e.g., 30SoC11). With a system-on-chip (e.g., 30SoC11), there is no need for provisioning, and there is no need to allocate resources like CPUs, memory, or PCIe cards (e.g., graphics processing units (GPUs), network interface controllers (NICs)) for the SoC. Therefore, unlike the live migration of an existing/traditional VM, the present invention achieves immediate/instant SoC provisioning, thereby eliminating/saving the time spent on allocating (computing, storage, or network) resources.

In an embodiment, with CXL 3.0, a system-on-chip (e.g., 30SoC11) may boot from the CXL shared memory among all CXL nodes (e.g., CPUs, devices) across servers or racks. The CXL shared memory may include a kernel (e.g., a Linux kernel) and a root filesystem with applications installed. In the booting procedure of a system-on-chip (e.g., 30SoC11), a boot loader inside the SoC may first load/boot the kernel residing on the CXL shared memory, then the kernel may mount the root filesystem to the root directory (marked by a slash “/”), and then the init scripts are executed as per their running levels accordingly. In an embodiment, the booting of a system-on-chip (e.g., 30SoC11) may not involve resource allocation.

In terms of security, the degree of isolation of a system-on-chip is higher than that of a virtual machine. The SoC hypervisor (e.g., 30HV1) may forbid/prohibit copying or pasting files from one system-on-chip (e.g., 30SoC11) to a host, a server (e.g., 30SVR1, 30SVR2) or another system-on-chip (e.g., 30SoC12, 30SoC2j). A firewall managing both network and PCIe is implemented inside a system-on-chip (e.g., 30SoC11) so that even a hacker compromises/breaches the host or the server (e.g., 30SVR1), the hacker needs to breach the system-on-chip (e.g., 30SoC11) as well to make the firewall allow copying or pasting of files. In other words, a VM essentially relies on software to simulate physical resources, but hardware-based security is better than software-based security (e.g., a software-based VM may be hacked by tampering with data in memory), Therefore, the present invention may directly run an operating system (e.g., 30OS11) or an application on a system-on-chip (e.g., leaving virtual machine(s) absent from the SoC) to improve security.

In an embodiment, a system-on-chip (e.g., 20R1SoC11 or 30SoC11) may include a plurality of cores, such as 8 ARM cores or 50 RISC-V cores. An ARM core may be used for data processing (e.g., Internet protocol security (IPsec), a virtual switch (e.g., OpenvSwitch), or other kinds of data processing) or a protocol engine for accelerating or simulating hardware. A RISC-V core may be used for signal processing, such as baseband processing (for satellite or 5G) or other kinds of signal processing or acceleration. In an embodiment, the number of RISC-V cores may be greater than the number of ARM cores. In the present invention, ARM core(s) or RISC-V core(s) inside a system-on-chip (e.g., 30SoC11) may be used to simulate an arithmetic logic unit (ALU) inside a GPU. Given a GPU may perform data and signal hardware acceleration, RISC-V core(s) should be able to do hardware acceleration as well.

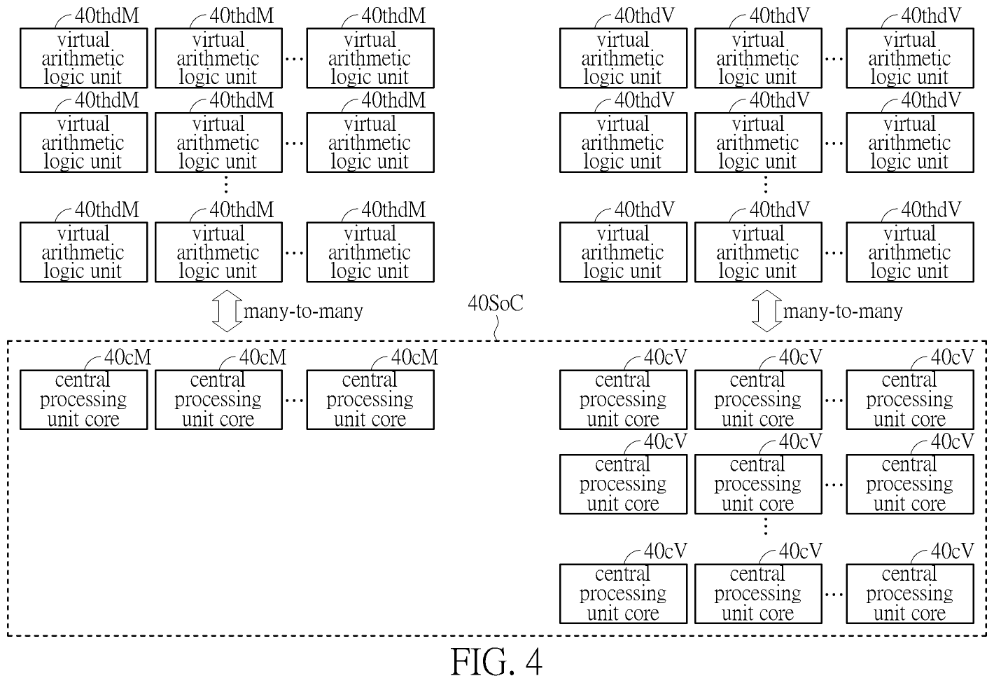

FIG. 4 is a schematic diagram of a system-on-chip 40SoC according to an embodiment of the present invention. The system-on-chip 40SoC may include a plurality of CPU cores 40cM and 40c V. If the number of the CPU cores 40cM belonging to ARM core is 8, the number of virtual arithmetic logic units (vALU) 40thdM for data processing may be greater than 8 (e.g., 16), and many-to-many scheduling/mapping may be performed. If the number of the CPU cores 40cV belonging to RISC-V core is 50, the number of virtual arithmetic logic units 40thdV for signal processing may be greater than 50 (e.g., 100), and many-to-many scheduling/mapping may be performed. Here one thread may represent one vALU. In other words, vALUs may be divided into two categories, and each category of vALUs may conduct a many-to-many scheduling. Moreover, the CPU cores 40cM and 40c V of the SoC 40SoC may be used to simulate the ALUs of a GPU so as to execute AI acceleration.

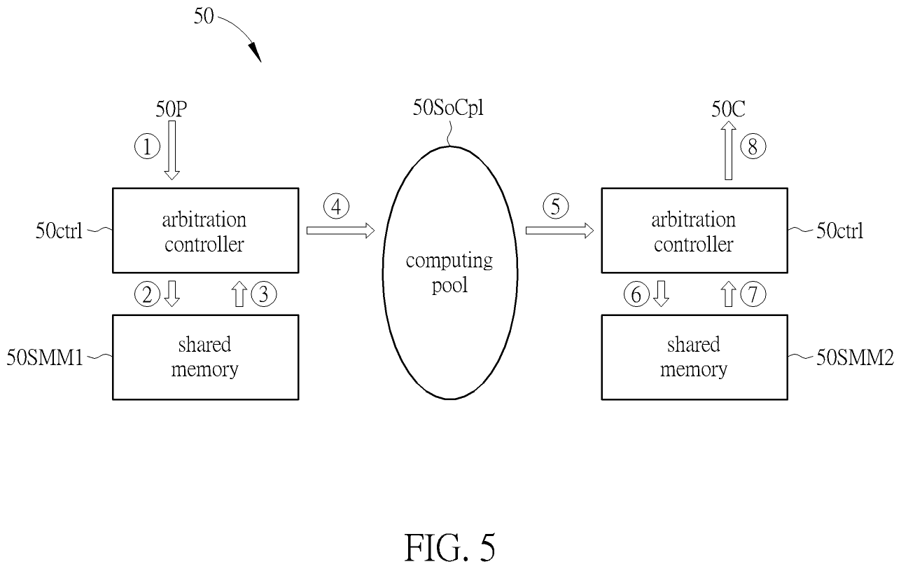

Accordingly, a system-on-chip (e.g., 30SoC11) may achieve data and signal hardware acceleration without including a GPU (i.e., leaving GPU(s) absent from the SoC). This reduces costs, increases design flexibility (by being not limited by the size of a GPU), and improves efficiency (by increasing or decreasing SoCs of the computing pool 50SoCp1 shown in FIG. 5).

FIG. 5 is a schematic diagram of a system 50 according to an embodiment of the present invention. The system 50 may include a producer 50P, an arbitration controller 50ctr1, shared memory 50SMM1, 50SMM2, a computing pool 50SoCp1, and a consumer 50C.

In an embodiment, the shared memory 50SMM1 (or 50SMM2) may be, for example, a CXL shared memory. The shared memory 50SMM1 (or 50SMM2) may be formed from part or all memory of SoC(s) or server(s) or the combination thereof. The shared memory 50SMM1 (or 50SMM2) may be implemented by the shared memory (e.g., 10SMM) of the systems 10, . . . , or 30. The shared memory 50SMM1 and 50SMM2 may be different shared memory or the same shared memory.

In an embodiment, the producer 50P may be a system-on-chip of the computing pool 50SoCp1, data source(s), or thread(s) for producing data. The consumer 50C may be a system-on-chip of the computing pool 50SoCp1 or thread(s) for consuming data. In an embodiment, the arbitration controller 50 ctrl may be used to lock/unlock the shared memory 50SMM1 or 50SMM2. In an embodiment, the producer 50P, the arbitration controller 50ctr1, or the consumer 50C may be implemented using a combination of software, firmware, or hardware.

In an embodiment, the producer 50P and the computing pool 50SoCp1 may access the shared memory 50SMM1 through the arbitration controller 50ctr1 such that atomic operations are ensured for input data. In other words, the producer 50P may produce data and write the data into the shared memory 50SMM1 (e.g., step S702), and the computing pool 50SoCp1 may read the data from the shared memory 50SMM1 (e.g., step S704). To avoid conflicts between the write operation of the producer 50P and the read operation of the computing pool 50SoCp1, the arbitration controller 50ctr1 may perform arbitration (e.g., lock certain memory or certain storage unit(s) and decide the operation): When the computing pool 50SoCp1 reads (e.g., certain storage unit), the arbitration controller 50ctr1 may prohibit/prevent the producer 50P from writing (e.g., the storage unit). When the producer 50P performs a write operation, the arbitration controller 50ctr1 may prohibit/prevent the computing pool 50SoCp1 from performing a read operation. Similarly, the consumer 50C and the computing pool 50SoCp1 may access the shared memory 50SMM2 through the arbitration controller 50ctr1 such that atomic operations are ensured for output data. To avoid conflicts between the write operation of the computing pool 50SoCp1 and the read operation of the consumer 50C, the arbitration controller 50ctr1 may perform arbitration: When the computing pool 50SoCp1 performs a write operation, the arbitration controller 50ctr1 may prohibit/prevent the consumer 50C from performing a read operation. When the consumer 50C performs a read operation, the arbitration controller 50ctr1 may prohibit/prevent the computing pool 50SoCp1 from performing a write operation. In other words, once the arbitration controller 50ctr1 performs locking, only one of the producer 50P, the computing pool 50SoCp1, and the consumer 50C may operate.

In an embodiment, the computing pool 50SoCp1 is a system-on-chip pool, which is formed/constituted/pooled by a plurality of SoCs (of the same or different server(s), chassis or rack(s)) (or computing resources of the SoCs). For example, a plurality of CPUs of a plurality of SoCs may constitute the computing pool 50SoCp1.

In an embodiment, the computing pool 50SoCp1 may have performance metrics. According to the performance metrics, if the performance of the computing pool 50SoCp1 or its SoC(s) is lower or higher than expected, the performance may be fine-tuned preventively in advance by adding/removing at least one SoC into/from the computing pool 50SoCp1. For example, please refer to FIG. 2 and FIG. 5 together. The computing pool 50SoCp1 may include the system-on-chips 20R1SoC11-20RiSoC1n shown in the first row of FIG. 2 at a time instant t1. If it is determined (using an algorithm) that the performance at a time instant t2 is insufficient (e.g., the algorithm determines that the performance metrics is lower than a preset performance metrics threshold, or that at least one element of a difference vector obtained by subtracting the corresponding performance metrics threshold vector from a performance metrics vector (e.g., ηₕ(t)), which includes at least one performance metrics, is less than 0), the system-on-chips 20R1SoC21-20R2SoC2n shown in the second row of FIG. 2 may be added to the computing pool 50SoCp1. If it is determined (using the algorithm) that the performance at the time instant t2 is still insufficient, the system-on-chips 20R3SoC21-20RiSoC2n shown in the second row of FIG. 2 or all the remaining system-on-chips 20R3SoC21-20RiSoCmn may be added to the computing pool 50SoCp1. Thereafter, if it is determined (using the algorithm) that the performance at a time instant t3 is excessive (e.g., the algorithm determines that the performance metrics is higher than the preset performance metrics threshold, or that all elements of the difference vector obtained by subtracting the corresponding performance metrics threshold vector from the performance metrics vector are greater than or equal to 0), the system-on-chips 20R1SoC21-20R2SoC2n shown in the second row of FIG. 2 may be removed from the computing pool 50SoCp1. As a result, the system-on-chips 20R1SoC11-20RiSoC1n, which constitute the computing pool 50SoCp1 and shown in the first row of FIG. 2, may execute one operation/calculation/task, while the system-on-chips 20R1SoC21-20RiSoC2n, which constitute/form/join another computing pool and shown in the second row of FIG. 2, may execute another operation/calculation/task. In other words, the present invention allows change in the composition of the computing pool 50SoCp1 corresponding/according to the producer 50P or the consumer 50C.

In one embodiment, the predictive analytics of performance metrics of the computing pool 50SoCp1 may be carried out using a continuous time structural equation modeling (CTSEM) so as to predict the performance at certain time instant (e.g., a time instant t, lim_{Δt→0} t+Δt, or lim_{Δt→0} t+2×Δt), as opposed to the performance in a time step using a discrete-time model, which can only deal with certain time step(s) (e.g., a time step t, t+Δt, or t+2×Δt). Since CTSEM may involve (random/stochastic) differential equations, it belongs to continuous-time operations/computations, and it catches/extracts temporal causal relations to make accurate predictions, thereby enabling better monitoring of performance or predicting whether performance metrics at the next time point (e.g., t) will fall below or exceed their corresponding performance thresholds.

For example, in CTSEM, performance metrics, which serve as temporal causal variables, constitute a performance metrics vector ηₕ(t), which is a function of time. Over time, the performance metrics vector ηₕ(t), which includes at least one performance metrics, may satisfy ηₕ(t)=e^{A(t-t}^{₀}⁾ηₕ(t₀)+A⁻¹[e^{A(t-t}^{₀}⁾−1]ζₕ+A⁻¹[e^{A(t-t}^{₀}⁾−I]Bzₕ+M Σᵤ x_{h,u}δ(t−u)+∫ₜ_{₀}^{t}e^{A(t-s)}GdWₕ(s) (Equation 1), or dηₕ(t)=(Aηₕ(t)+ζₕ+Bzₕ+M Σᵤx_{h,u}δ(t−u))dt+GdWₕ(t) (Equation 2). The matrix A may use auto effects on the diagonal and cross effects on the off-diagonal to qualitatively characterize/capture the temporal relationships of the performance metrics vector ηₕ(t). The matrix I is the identity matrix. The random vector ζₕ may determine the long-term trend/level of the performance metrics vector ηₕ(t) and may follow/satisfy a distribution ζₕ˜N(K, ϕ_{ζ}), where the vector K may represent continuous time intercept(s), and the matrix ϕ_{ζ} may represent a covariance (e.g., the covariance across SoCs). The matrix B may represent the effect of a (fixed) time-independent predictor vector zₕ on the performance metrics vector ηₕ(t), and the number of rows of the matrix B may differ from the number of columns of the matrix B. The time-independent predictor vector zₕ may usually be variables that differs between different SoCs, but may be constant corresponding to different SoCs for the time range in question. The time-dependent predictor vector x_{h,u} may be observed at a time instant u and may be treated as impacting the performance metrics vector ηₕ(t) only at the time instant u, and the effect of impulses, each of which is formed/described by x_{h,u}δ(t−u), on the performance metrics vector ηₕ(t) may be represented by the matrix M. The vectors Wₕ(s) may be independent random walks in continuous time (e.g., Wiener processes), and dWₕ(s) may be a stochastic error term. The lower triangular matrix G may represent the effect on changes of the performance metrics vector ηₕ(t). The matrix Q satisfying Q=GG^{T} may represent a variance-covariance matrix of the diffusion process in continuous time. The (component) value(s) of the matrix A, B, M, G, the vector ζₕ, zₕ, x_{h,u}, Wₕ(s), the time instant u, or the initial time instant to may be obtained/determined/calculated by fitting Equation 1 or 2 to data related to SoC(s) of the computing pool 50SoCp1 (e.g., existing performance metrics). Over time, when the performance metrics vector ηₕ(t) of temporal causal variables (including performance metrics) has one or more of the performance metrics higher/lower than expected, the performance may be preventively fine-tuned beforehand.

CTSEM is focused on providing an accessible workflow, for full information maximum likelihood estimation of continuous time multivariate autoregressive models (with random intercepts), for both time series and panel data. In one embodiment, the dynamic random process modeled is one process (i.e., a time series and a single device) as opposed to multiple processes (i.e., panel data and multiple devices); correspondingly, h of the performance metrics vector ηₕ(t) may be equal to 1, and there is only one performance metrics vector η₁ (t). The performance metrics vector η₁ (t) may include performance metrics of at least one SoC of a computing pool (e.g., 50SoCp1), and each SoC has at least one performance metrics. In another embodiment, the performance metrics vector ηₕ(t) with h ranged from 1 to n may correspond to different computing pools, so n computing pools may correspond to the performance metrics vectors η₁ (t) to ηₙ (t), respectively, where h and n are positive integers.

FIG. 6 is a schematic diagram of a system 60 according to an embodiment of the present invention. The system 60 may be implemented using any of the systems 10-50. Live migration may involve resuming the state of one SoC (e.g., a user plane function of a core network or other network element(s)) to another SoC, while it operates/functions normally in the latter SoC. A network element may be software, a VM, or a container, and may be booted on a host (e.g., an x86 host or server). However, the system 60 does not use/employ/include VM(s); instead, the system 60 allows network element(s) to directly use the resources of the SoC(s). The system 60 ensures that the latency from a camera to an AI server is less than 1 millisecond.

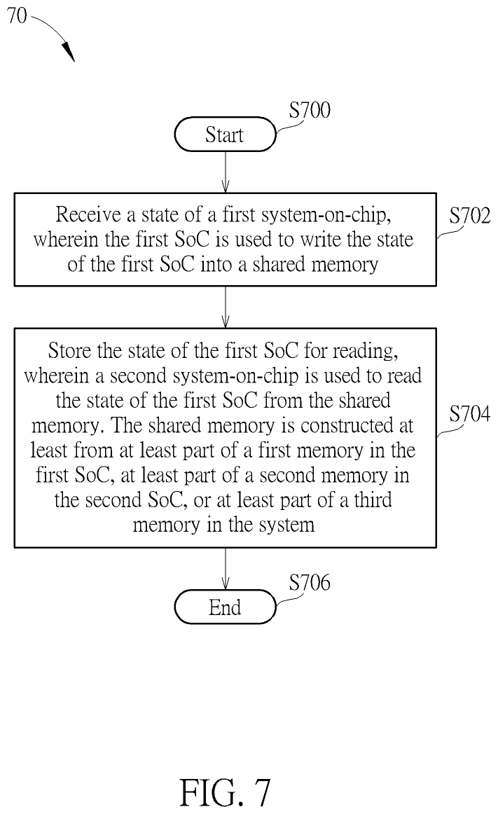

FIG. 7 is a schematic diagram of a live migration method 70 according to an embodiment of the present invention. The live migration method 70 may be compiled into a program code, and may be applied to a shared memory of a system (e.g., 10-60). The live migration method 70 may include the following steps:

### Step S700: Start.

Step S702: Receive a state of a first system-on-chip (e.g., 20R1SoC11), wherein the first SoC is used to write the state of the first SoC into a shared memory.

Step S704: Store/save the state of the first SoC for reading, wherein a second system-on-chip (e.g., 20R2SoC11) is used to read the state of the first SoC from the shared memory. The shared memory is constructed/formed at least from at least part of a first memory in the first SoC, at least part of a second memory in the second SoC, or at least part of a third memory in the system.

### Step S706: End.

The technical features described in the embodiments (e.g., systems 10-60) may be mixed or combined in various ways or implemented according to another embodiment as long as there are no conflicts between them. In an embodiment, the state of a system-on-chip may include the content or state of its CPU(s), memory, storage, or network connection. Any one of the system-on-chips 20R1SoC11-20RiSoCmn, 30SoC11-30SoC1n, 30SoC21-30SoC2j, and 40SoC may be implemented by the device 10SoC1 or 10SoC2.

To sum up, the present invention replaces VMs with SoCs and uses CXL 3.0 to perform seamless SoC live migration across servers or racks, thereby avoiding interrupts and providing better user experience on the edge computing platform at edge cloud. The present invention may achieve instant SoC provisioning, thereby providing shorter latency and faster response on the edge computing platform at edge cloud. The present invention has better SoC isolation, so the edge computing platform at edge cloud may provide hardware-based security which is better than software-based one. A system-on-chip of the present invention may perform (data and/or signal) hardware acceleration on behalf of host (or server), thereby saving lots of expensive CPU cores on host. A system-on-chip of the present invention may be put into a pool to achieve SoC pooling and process data or signals on a producer/consumer basis.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A live migration method, for a shared memory of a system, comprising:
receiving a state of a first system-on-chip (SoC), wherein the first SoC is configured to write the state of the first SoC into the shared memory; and
storing the state for reading, wherein a second SoC is configured to read the state from the shared memory,
wherein the shared memory is constructed at least from at least part of a first memory of the first SoC, at least part of a second memory of the second SoC, or at least part of a third memory of the system.

2. The live migration method of claim 1, wherein the first SoC and the second SoC are disposed in different servers, chassis, or racks.

3. The live migration method of claim 1, wherein the first SoC or the second SoC does not use a network to copy or transmit the state.

4. The live migration method of claim 1,
wherein no virtual machine is installed within the first SoC or the second SoC, and
wherein neither virtual machine provisioning nor virtual machine resource allocation is required on the second SoC before the state is resumed on the second SoC.

5. The live migration method of claim 1, wherein the second SoC is configured to read the state from the shared memory to resume the state on the second SoC, and the second SoC is configured to operate according to the state.

6. The live migration method of claim 1, wherein the first SoC is configured to utilize at least one central processing unit core of the first SoC to simulate an arithmetic logic unit of a graphics processing unit (GPU), and the first SoC does not include any GPU.

7. The live migration method of claim 1, wherein an arbitration controller is configured to determine whether the first SoC or the second SoC is allowed to access the shared memory, and is configured to lock or unlock the shared memory to prevent a read operation and a write operation from occurring simultaneously.

8. The live migration method of claim 1, wherein a computing pool of the system includes a plurality of processors of a plurality of SoCs, and the plurality of SoCs include the first SoC or the second SoC.

9. The live migration method of claim 8, wherein the system is configured to predict at least one performance metrics of each of the plurality of SoCs in the computing pool according to a continuous time structural equation model, and is configured to determine whether the at least one performance metrics is lower than or higher than at least one performance metrics threshold so as to determine whether to increase or decrease a number of the plurality of SoCs in the computing pool.

10. The live migration method of claim 9, wherein a performance metrics vector ηₕ(t) formed by the at least one performance metrics of the plurality of SoCs of the computing pool satisfies ηₕ(t)=e^{A(t-t}^{₀}⁾ηₕ(t₀)+A⁻¹[e^{A(t-t}^{₀}⁾−I]ζₕ+A⁻¹[e^{A(t-t}^{₀}⁾−I]Bzₕ+M Σᵤx_{h,u}δ(t−u)+∫ₜ_{₀}^{t}e^{A(t-s)}GdWₕ(s), where A denotes a qualitative matrix, to denotes an initial time instant, I denotes an identity matrix, ζₕ denotes a random vector, B denotes a transformation matrix, zₕ denotes a time-independent predictor vector, M denotes a coefficient matrix, x_{h,u} denotes a time-dependent predictor vector, u denotes a pulse time instant, Wₕ(s) denotes a random walk vector, and G denotes a lower triangular matrix.

11. A system, comprising:
a first system-on-chip (SoC), configured to write a state of the first SoC into a shared memory; and
a second SoC, coupled to the first SoC, configured to read the state from the shared memory,
wherein the shared memory is constructed at least from at least part of a first memory of the first SoC, at least part of a second memory of the second SoC, or at least part of a third memory of the system.

12. The system of claim 11, wherein the first SoC and the second SoC are disposed in different servers, chassis, or racks.

13. The system of claim 11, wherein the first SoC or the second SoC does not use a network to copy or transmit the state.

14. The system of claim 11,
wherein no virtual machine is installed within the first SoC or the second SoC, and
wherein neither virtual machine provisioning nor virtual machine resource allocation is required on the second SoC before the state is resumed on the second SoC.

15. The system of claim 11, wherein the second SoC is configured to read the state from the shared memory to resume the state on the second SoC, and the second SoC is configured to operate according to the state.

16. The system of claim 11, wherein the first SoC is configured to utilize at least one central processing unit core of the first SoC to simulate an arithmetic logic unit of a graphics processing unit (GPU), and the first SoC does not include any GPU.

17. The system of claim 11, wherein an arbitration controller is configured to determine whether the first SoC or the second SoC is allowed to access the shared memory, and is configured to lock or unlock the shared memory to prevent a read operation and a write operation from occurring simultaneously.

18. The system of claim 11, wherein a computing pool of the system includes a plurality of processors of a plurality of SoCs, and the plurality of SoCs include the first SoC or the second SoC.

19. The system of claim 18, wherein the system is configured to predict at least one performance metrics of each of the plurality of SoCs in the computing pool according to a continuous time structural equation model, and is configured to determine whether the at least one performance metrics is lower than or higher than at least one performance metrics threshold so as to determine whether to increase or decrease a number of the plurality of SoCs in the computing pool.

20. The system of claim 19, wherein a performance metrics vector ηₕ(t) formed by the at least one performance metrics of the plurality of SoCs of the computing pool satisfies ηₕ(t)=e^{A(t-t}^{₀}⁾ηₕ(t₀)+A⁻¹ [e^{A(t-t}^{₀}⁾−I]ζₕ+A⁻¹[e^{A(t-t}^{₀}⁾−I]Bzₕ+M Σᵤx_{h,u}δ(t−u)+∫ₜ_{₀}^{t}e^{A(t-s)}GdWₕ(s), where A denotes a qualitative matrix, to denotes an initial time instant, I denotes an identity matrix, ζₕ denotes a random vector, B denotes a transformation matrix, zₕ denotes a time-independent predictor vector, M denotes a coefficient matrix, x_{h,u} denotes a time-dependent predictor vector, u denotes a pulse time instant, Wₕ(s) denotes a random walk vector, and G denotes a lower triangular matrix.
